(19) United States
(12) Patent Application Publication
(10) Pub. No.: US 2005/0164664 A1
(43) Pub. Date: Jul. 28, 2005

(54) Dynamically reconfigurable wireless networks (DRWiN) and methods for operating such networks

(76) Inventors: Daniel F. DiFonzo, Rockville, MD (US); Kenneth Hersey, Clarksville, MD (US); Ernest P. Ekelman, Damascus, MD (US); Shuguang Chen, Ellicott City, MD (US); Louise C. Sengupta, Ellicott City, MD (US); Somnath Sengupta, Ellicott City, MD (US); Thomas H. Scholl, Gaitherburg, MD (US)

Correspondence Address: James S. Finn;c/o William Tucker, Box #8, 14431 Goliad Dr., Malakoff, TX, 75148, US

(21) Appl. No.: 11/079,311

(22) Filed: Mar. 14, 2005

Related U.S. Application Data
(63) Continuation of application No. 09/620,776, filed on Jul. 21, 2000.

(51) Int. Cl. H04B 1/06

(52) U.S. Cl. 455/277.1; 455/562.1; 455/12.1

(57) ABSTRACT

A mesh type wireless communication network includes a plurality of nodes, each node having at least one dynamically directionally controllable communications link, and a network controller for dynamically changing the direction of the controllable communications links of the nodes to enable transmission of signals between the nodes. A hub type wireless communication network includes a hub node having at least one dynamically directionally controllable communications link, a plurality of remote nodes, and a network controller for dynamically controlling the direction of the communications link to enable transmission of signals between the hub node and the remote nodes. A method for transmitting communications signals in a mesh network includes the steps of providing a plurality of nodes for receiving communications signals, each having at least one dynamically directionally controllable communications link, and dynamically changing the direction of the controllable communications links of the nodes to enable transmission of the communications signals between the nodes. A method for transmitting communications signals in a hub network includes the steps of providing a hub of node for receiving communications signals, the hub node having at least one dynamically directionally controllable communications link, providing a plurality of remote nodes for exchanging the communications signals with the hub node, and dynamically changing the direction of the controllable communications links of the hub node to enable transmission of the communications signals between the hub node and the remote nodes.

### BACKGROUND OF THE INVENTION

This invention relates to wireless communications networks and methods for operating such networks.

Wireless communications networks are rapidly being deployed to serve communications needs. For example, point-to-point (P-P) and point-to-multipoint (P-MP) microwave networks, known as local multipoint distribution services (LMDS) and operating in allocated subsets of the 24 to 42 GHz frequency band, are being developed and deployed to serve a wide variety of communications applications such as voice, internet, data, and video for businesses and residences. Another example is a Multichannel Multi-point Distribution Systems (MMDS) operating in the 2.1-2.7 GHz spectrum. These systems are sometimes referred to collectively as Multipoint Distribution Systems (MDS).

These networks may be configured in a number of ways. Point-to-point wireless networks employ microwave transceivers comprising receivers, transmitters and directional antennas between two nodes. Point-to-multipoint (P-MP) networks interconnect several nodes. For P-MP networks, the interconnection topologies may take several forms including that of a hub and spoke (star), or mesh configuration.

The hub topology incorporates transceivers at a central node (hub or base station) that communicate with a number of terminals at user sites. Each user site communicates only with its hub. The hub sites are then interconnected to a “backbone” network that usually includes either coaxial or fiber optic transmission lines or, in some cases, a P-P microwave link. The backbone lines are consolidated and connected to trunk networks for interconnection to the Internet and other communications networks.

A mesh network allows for each node to interconnect with more than one other node. A signal is routed through the mesh network from node to node until it reaches a node that is either its destination or, if it is destined for a location outside the local network, a node that connects the signal to a backbone and/or trunk line.

At the early stage of deployment, hub networks are most prevalent. However, several advantages may be cited for mesh networks including greater interconnectivity, greater coverage potential for a given number of nodes in a metropolitan area, and better route diversity compared with hub systems. Mesh proponents believe that these networks can be more cost effective.

Network communications architectures can incorporate many modulation and access schemes. Access methods include frequency division multiple access (FDMA), time division multiple access (TDMA), code division multiple access (CDMA) or combinations of these. While CDMA is considered to have advantages for narrow-band systems such as for mobile voice and narrow or medium bandwidth data, the advantages of the spectrum spreading may be less significant for wideband systems where the spreading of an already wideband signal may exceed the allocated bandwidth. FDMA most readily applies to P-P links where users are separated by being assigned different frequency channels. In P-MP links, while FDMA may also be used, there may be advantages to using TDMA where users share a common frequency band but are assigned unique time slots. Of course, combinations of these access techniques are known and in use for various systems.

Modulation formats include, but are not limited to: quadrature phase shift keying (QPSK) and quadrature amplitude modulation (QAM) in a variety of dimensions, e.g. 16-QAM to 256-QAM. While QAM appears to offer better spectral efficiency, it has been contended that the effects of a clustered environment of users reduce the efficiency of QAM because the necessary signal-to-interference ratio (S/I) to maintain a constant bit error rate increases as the cluster size increases. Accordingly, the reduction in channels per sector offsets the increased bits/s/Hz afforded by high order QAM.

While wireless networks can be deployed relatively easily compared with wired networks, they nevertheless face several challenges and limitations. The relatively severe rain attenuation at frequencies above 20 GHz limits the distances between nodes for a given system availability. The quality of the radio link between nodes depends on the transmitted power, the link distance, the interference environment, and the gains of the transmitting and receiving antennas.

There is a tradeoff between the antenna gain and the area coverage of a link. Typically, service operators provide sector coverage with several antennas. As the antenna sector coverage is reduced, the antenna gain and the link are improved at the expense of coverage area. Therefore, more antennas are needed to cover the area. For example, a hub site may incorporate four antenna beams, each covering a 90-degree azimuth sector and each having a relatively narrow elevation beam or, alternatively, eight sector beams of 45° each. The link transmission could be improved by further narrowing the sector beams (thereby increasing their gain) at the added expense of requiring more antennas to fill in the coverage. Generally, a compromise is reached where a relatively small number of antennas (e.g. four) are employed either at a hub site or a mesh node and each antenna accommodates several users. For a given set of limitations on transmitter power, the number of nodes required to cover an area, such as a city, is higher than it would be if the radio link used antennas with high gain. Yet, the higher gain requires more antennas at each node, thereby increasing the equipment cost and complexity.

Arrays and steerable beam antennas have been recognized as having advantages to provide sector beams for cellular communications base station antennas to improve communications range and interference to and from mobile terminals. A key benefit is that gain can be increased to improve the communications link while still maintaining a fixed coverage sector.

U.S. Pat. No. 5,875,396 describes a sectorized broadcast system using spread spectrum signals to and from a base station where the sectorization is accomplished with multiple antenna panels. United States U.S. Pat. Nos. 5,621,752 and 6,009,124 disclose means for adaptive sectorization of the channels for a base station. This is primarily applicable to base stations communicating with mobile users.

U.S. Pat. No. 5,488,737 discloses the use of a scanning base station antenna to scan its beam until locating a remote terminal, stopping the beam for the duration of communications, and then resuming scan.

United States U.S. Pat. Nos. 5,771,017 and 5,596,329 describe a base station and mobile systems using multiple beams at the base station for improved cellular communications.

United States U.S. Pat. Nos. 5,548,813, 5,890,067, 5,953,325, 5,701,583, and 5,983,118 describe the use of various scanning beams applied to cellular systems.

The prior art recognizes the advantages of narrow sector beams and even the use of phased arrays and multiple beam antennas for such sectorization. However, the application of such antennas has typically been limited to the sectorization of a base station antenna and most of these applications are for cellular, mobile communications where the remote terminal typically has a non-directional or low gain antenna and the motivation for base station directivity and beam adaptation is to improve multipath, range, and interference properties.

There is a need for a wireless communications network that incorporates high-gain antennas while not requiring a correspondingly large number of individual radiating apertures to maintain full connectivity. None of the patents discussed above appears to address the specific application of steerable communications links to a complete network architecture wherein the use of narrow steerable beams has been generalized to apply to the base station, the user station, or even both in a controlled manner.

### SUMMARY OF THE INVENTION

This invention includes a wireless communication network comprising a plurality of nodes, each node having at least one dynamically directionally controllable communications link, and a network controller for dynamically changing the direction of the controllable communications links of the nodes to enable transmission of signals between the nodes. The invention further includes a hub type wireless communication network comprising a hub node having at least one dynamically directionally controllable communications link, a plurality of remote nodes which may or may not all have dynamic directional beam control, and a network controller for dynamically controlling the direction of the communications link to enable transmission of signals between the hub node and the remote nodes.

The invention also encompasses a method for transmitting communications signals comprising the steps of providing a plurality of nodes for receiving communications signals, each having at least one dynamically directionally controllable communications link, and dynamically changing the direction of the controllable communications links of the nodes to enable transmission of the communications signals between the nodes. The invention further encompasses a method for transmitting communications signals comprising the steps of providing a hub of node for receiving communications signals, the hub node having at least one dynamically directionally controllable communications link, providing a plurality of remote nodes for exchanging the communications signals with the hub node, and dynamically changing the direction of the controllable communications links of the hub node to enable transmission of the communications signals between the hub node and the remote nodes.

### BRIEF DESCRIPTION OF THE DRAWINGS

FIG. 1 is a schematic representation of a prior art hub type communications network;

FIG. 2 is a schematic representation of a prior art mesh type communications network;

FIG. 3 is a schematic representation of a hub type communications network constructed in accordance with one embodiment of the present invention;

FIG. 4 is a schematic representation of a dynamically reconfigurable wireless mesh type communications network constructed in accordance with another embodiment of the present invention;

FIGS. 5a, 5b, 5c and 5d are schematic drawings illustrating the operation of the communications network of FIG. 4;

FIGS. 6 and 7 are schematic drawings of antennas having a steerable radiation beam; and

FIGS. 8 and 9 are pictorial representations of antennas having a steerable radiation beam.

### DESCRIPTION OF THE PREFERRED EMBODIMENT

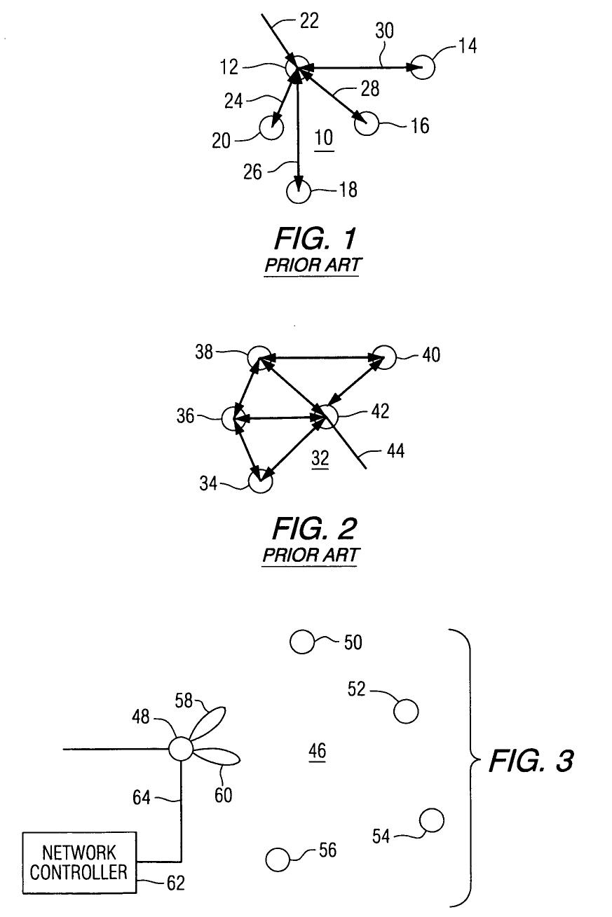

The present invention provides a dynamically reconfigurable wireless communications network. FIGS. 1 and 2 illustrate prior art hub and mesh communications network topologies. FIG. 1 is a schematic representation of a hub type communications network 10, which includes a hub node 12 that communicates with a plurality of remote users 14, 16, 18 and 20. The hub 12 can also be connected to a backbone communications system as illustrates by line 22. In a wired network, the lines interconnecting the communications nodes would represent physical connections of transmission lines such as optical fiber or coaxial cable. For a wireless network, the connections represent radio links between antennas at each node. The arrows 24, 26, 28 and 30 indicate that two-way communications exist between nodes. Present-day hubs with 90° sector beams are limited to frequency reuse only in sectors with angular separation of 180° (i.e. front-to-back).

FIG. 2 is a schematic representation of a mesh type communications network 32. The network includes a plurality of nodes 34, 36, 38, 40 and 42, each of which can communicate with more than one other node. One of the nodes, for example 42, can be connected to an external backbone communications system as illustrated by line 44. Again the arrows in FIG. 2 indicate that two-way communications exist between the nodes.

The preferred embodiments of method and apparatus of this invention provide networks that incorporate antennas having electronically steerable high-gain beams at the nodes of the network. FIG. 3 is a schematic representation of a hub type communications network 46 constructed in accordance with one embodiment of the present invention. The network includes a hub node 48 and a plurality of remote users 50, 52, 54 and 56. The remote users may represent any of a variety of applications. One example is for fixed site users, e.g. in a building, where the remote equipment (customer premises equipment or CPE) is used to enable a wireless broadband connection to the base station, either directly, or as a way for the CPE to connect to a backbone. In mesh-connected networks, the user site may be both a remote site and a “base station” for relay connections to other sites. Another application is for portable user equipment. For example, a user may carry a laptop computer to many different sites. A portable steerable beam antenna (whether steered by commend or adaptively steered) could be used to “point” the beam so as to maintain maximum signal strength and maximum signal-to-interference ratios while communicating with the base station. This concept is readily generalized to mobile stations, e.g. in moving vehicles, to maintain optimum signal conditions for voice and/or data communications, Internet access, or private network access. In such a case, it may be likely that both the base station antenna and the mobile antenna would incorporate steerable beam antennas.

The hub node includes a steerable beam antenna that produces one or more steerable radiation beams, as illustrated by beam patterns 58 and 60. Alternatively, the hub node could include a multiple beam antenna, wherein the various beams can be switched on or off when communications with particular remote users are desired. A network controller 62 directs the hub node to point a steerable beam in the direction of the remote users to establish a communications link therewith. The network controller 62 initially obtains its adaptive beam steering commands through an initial calibration and subsequent broad detection with a wide beam. This wide beam enables all new or moved signals to be updated in its algorithm. This algorithm then either decodes the positions to absolute phase settings for each of the elements or columns of elements in a phased array antenna, or selects appropriate feed point for a multiple beam antenna. This decoding can take place from a priori knowledge of command angle versus phase command sets, or through mathematical calculation. As the hub provides communication, a burst of each frame is dedicated to the establishment of new users and re-pointing of mobile users, to keep the adaptive network controller up-to-date with its current communication links. While the network controller is shown connected to the hub node by line 64, other methods of coupling control signals to the hub node, such as by a radio link, can also be used.

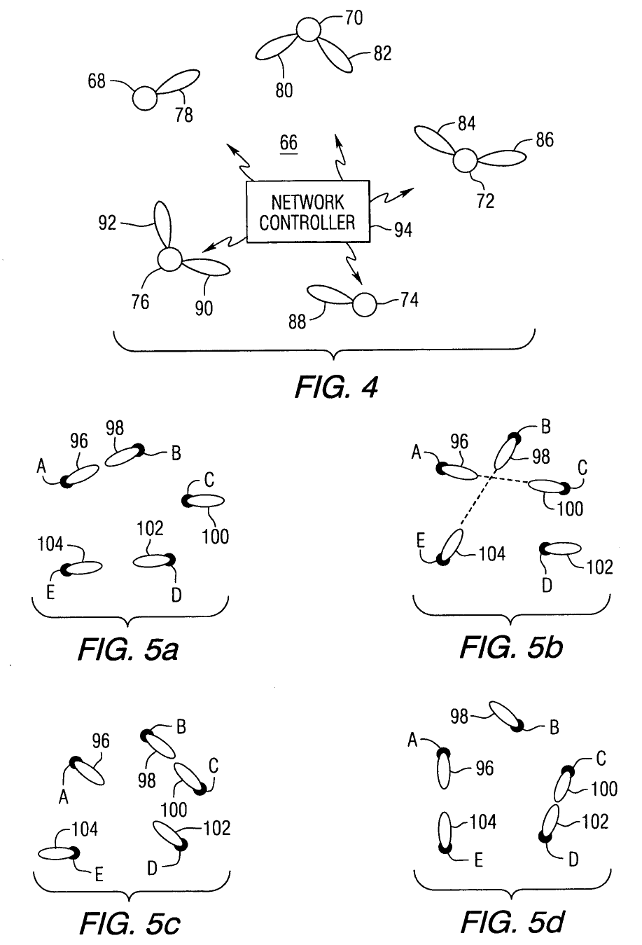

FIG. 4 is a schematic representation of a mesh type communications network 66 constructed in accordance with one embodiment of the present invention. The network includes a plurality of nodes 68, 70, 72, 74 and 76. At least some of the nodes include a multiple beam, or steerable beam antenna that produces one or more radiation beams, as illustrated by beam patterns 78, 80, 82, 84, 86, 88, 90 and 92. A network controller 94 directs the nodes to point their beams in the direction of other nodes or remote users to establish a communications link therewith. The network(s) incorporating steerable and/or multiple beams are typically (but not necessarily) connected to outside networks by a wired connection to a backbone network. For example, fiber optic cables or leased high-capacity lines may be connected to a base station. The base station then communicates with other nodes in the wireless network and thereby effects a connection from any remote CPE to the larger outside network, e.g. the Internet or other wide area networks (WANs). In a mobile environment, mobile users connect to the base stations and from there are connected, for example, to the public switched telephone network (PSTN) or to the Internet, or to other private WANs.

In one preferred embodiment, communications links are formed by narrow beams produced by a radiating aperture can be pointed in different spatial directions by electronic means, requiring no mechanical movement of the antenna aperture. The designation “narrow beams” is usually relative to the conventional beamwidths used for sectorization. Narrow beams, in this context, refer to beams that have a substantially smaller angular extent than the sector beams commonly used. For example, sector beams for fixed wireless applications may range from 90° to 15-30°, depending on the sectorization parameters. In order to improve antenna gain and reduce interference, typical narrow beam solutions may incorporate beamwidths substantially less than 15°, e.g. 2°-10°. The invention includes communications networks that incorporate such antennas that exploit the dynamic pointing of their beams to improve the connectivity and capacity of wireless networks.

For a given transmitter power and distance, the use of narrow beam communication links maximizes the received signal-to-noise ratio or service quality, usually defined as a percentage of time for which the bit error rate shall be less than a specified maximum value. Alternatively, higher gain could allow lower transmitted power and/or increased distance between nodes for a given service quality. In the ideal case, a network would provide the highest practical transmit and receive antenna gain for each node in the direction of the node(s) with which it communicates.

Another advantage of narrow, high-gain beams is that allocated or licensed frequencies could be reused to increase the total communications capacity of the network. Beams pointing in different directions from a node could reuse the same spectrum provided that the sidelobes of the transmitting beams do not send unwanted interference in the direction of other receiving beams tuned to the same frequencies. A corresponding benefit accrues to the narrow receiving beams because their sidelobes present a relatively low antenna gain to signals arriving from outside their main beam pointing direction.

Steerable-beam antennas can take the form of phased arrays or other lens or reflector optics configurations with either single or multiple beams from the same aperture where each beam is independently steerable. Representative examples of such antennas will be described herein. The present invention does not depend upon a particular antenna structure, but rather uses the systematic incorporation and control of single-beam and/or multiple-beam antennas with dynamically and electronically steerable or switchable beams into a wireless network to improve link quality and to generalize the instantaneous connectivity of the network.

The networks of the present invention may be called a “dynamically reconfigurable wireless network” or even a “dynamically re-connectible wireless network”. In such networks, the narrow beams must be capable of being steered by command or other well understood network control means (e.g. by a scheduling algorithm) to systematically cover all nodes in the intended area. Alternatively, a single multi-beam aperture may contain a number of simultaneous fixed beam positions, which are selectively activated (beam switching).

Narrow scanning beam or/and single multi-beam antennas will be needed to switch their beams to one fixed user or moving users in TDMA or other communications systems for the purpose of getting high quality connections without any interference. The control algorithm of how to switch beams can be saved in memory in advance or can depend on the signals received from the users. The network will generate or change the beam forms and/or directions according to the signals received from the users.

The invention may be easily understood in the context of a TDMA system although, as will be pointed out, it may also be applied to other networks. In the TDMA description, system, links are set up on a moment-to-moment basis between nodes within the field of view of the steerable beam antenna. The “moments” are typically individual burst time periods (“time slots”) within a TDMA transmission frame time. Depending on the traffic to and from a given user, the network control, according to well understood principles for TDMA burst and time plan assignments, would assign a number of time slots to a user—a few time slots per frame for a light user and more slots for a heavy user. Therefore, the connection time to a user depends on its traffic. When the bursts are to be directed to another user in a known but different direction, the beam is also commanded to steer towards the next user and remains pointed to it until the assigned number of time slots is used, then the beam is directed to yet another user and so forth. Additional time may also be allocated for a broad-beam mode to enable detection and incorporation of new nodes in the network. Finally, as traffic increases, additional beams can be generated from the same antenna and independently steered as described to increase system capacity. For adaptively steered antennas, the beams would be steered according to methods known in the art and described in some of the other referenced patents, to apply weighting coefficients to the amplitudes and phases of the individual radiating elements or subarrays of the base station and/or remote antennas in order to maximize the link quality (for example, S/N, S/I, or minimum bit error rate).

For clarity of description, the antennas may be assumed herein to be phased array antennas but other antenna types may also serve this purpose including, but not limited to, reflectors with multiple feeds, space-fed lenses, and multi-beam arrays with Butler matrix or Rotman lens beam forming networks. The essential feature of the antennas is that they be able to form narrow, high gain beams in multiple spatial directions upon command or upon selection of an appropriate beam port in a multiple beam antenna.

Reference is now made to FIGS. 5a, 5b, 5c and 5d, which illustrate a simple, but representative, network of five nodes. It is possible, but not necessary for this description, that one or more nodes may be connected to a backbone circuit.

Consider the state of the network at an arbitrary time slot (no. 1) within a TDMA frame as shown in FIG. 5a. Here, nodes A and B (for example) are connected by commanding the transmit and receive beams 96, 98 of nodes A and B to point to each other. At this same instant of time, nodes D and E are interconnected through beams 102 and 104 while the beam 100 of node C is pointed and interconnected with a node outside those shown in the figure. At subsequent time slots as illustrated in FIGS. 5b-d, different interconnection arrangements may be in effect.

Therefore, at each assigned burst time slot, the effect is as though a direct “wired” connection existed between each node wherein the entire “wiring diagram” or connection diagram can be reconfigured at each instant. This may also be viewed as a connection matrix at each instant of time where a “1” represents a connection between nodes and a “0” represents no connection, as depicted in Table 1 for the case of FIG. 5a.

TABLE 1
Instantaneous Connection Diagram for Connection of FIG. 5a.

| | A | B | C | D | E | Out |
|---|---|---|---|---|---|---|
| A | 0 | 1 | 0 | 0 | 0 | Out |
| B | 1 | 0 | 0 | 0 | 0 | |
| C | 0 | 0 | 0 | 0 | 0 | 1 |
| D | 0 | 0 | 0 | 0 | 1 | |
| E | 0 | 0 | 0 | 1 | 0 | 0 |
| Out | 0 | 0 | 1 | 0 | 0 | 0 |

In Table 1, “Out” refers to a connection outside the five nodes shown in FIG. 5a. Another representation of the network status is shown in Table 2 where the connection matrix is depicted vs. time (t). This matrix may be viewed as a simplified form of a scheduling assignment to point the beams of each node in a specific direction at each unit of time. For node A, connection to node B implies a specific known pointing direction or set of angular coordinates (e.g. azimuth and/or elevation angle) to which the beam of node A is pointed and vice versa.

TABLE 2
Connection Matrix for Each Unit of Time.

| | t₁ | t₂ | t₃ | t₄ |
|---|---|---|---|---|
| A | B | C | D | E |
| B | A | E | C | Out |
| C | Out | A | B | D |
| D | E | Out | A | C |
| E | D | B | Out | A |

To the extent permitted by the angular separation between nodes, the signal isolation between nodes that do not have beams pointing toward each other is improved by the directivity of the beams. Electronic beam steering permits the beam directions to be reconfigured very rapidly as must occur, for example, in the guard time interval between adjacent time slots in a TDMA system (typically less than 1 microsecond or, at most, a few microseconds depending on the communications parameters).

The invention may be generalized to include the special case where the transmitting and receiving beams of a node are not necessarily pointed at the same location. For example, if separate receive and transmit beams are used at the same node, either by separate apertures or separate beams in the same aperture, node A may be transmitting to node B while receiving a signal from node C. In this case, one can conceptually draw a connection diagram for transmit and a separate, “overlaid”, diagram for the receive connections.

A further generalization can be made for frequency reuse wherein each node can form multiple beams, some or all of which can reuse the same frequency band. In this case, the conceptual wiring diagram is that of several independent overlaid networks, each having its own instantaneous wiring diagram. In this case, the beam positions must obey spatial and/or polarization restrictions that are well known for reusing frequencies from multiple beams.

The advantages of the directive beams for improving the link margin or, alternatively, using less radio frequency (RF) power for a given link margin can be readily appreciated. A radio link is typically characterized by the well known link equation in which the ratio of received signal power to the thermal noise is proportional to the transmitted power (pₜ) and the gains of the transmit and receive antennas (gₜ and gᵣ):

$$\frac{c}{n} = {K}_{1} {p}_{t} {g}_{t} {g}_{r} = \frac{{K}_{1} {K}_{2} {p}_{t}}{{Ω}_{t} {Ω}_{r}}$$

In this equation, the subscripts t and r denote “transmit” and “receive” respectively and K₁ and K₂ are constants that absorb the other terms in the link equation. The gains are inversely proportional to the solid angle subtended by the beams Ωₜ and Ωᵣ. Therefore, as the beams are narrowed, i.e. made more directive, the gain increases. Also, not explicitly depicted in the above equation, the important signal quality measure in a dense communications environment with many users is that of the ratio of received signal power to the sum of thermal noise power and interference power. It is readily appreciated by those skilled in the communications art that this quantity is generally improved with directive antennas because they can discriminate between signals arriving from a desired direction and those arriving from other directions.

The beam pointing used in networks of this invention is straightforward because the geographical locations of the nodes are known and fixed. At another time slot, node A may be commanded to point its transmit and receive beams toward node C and vice versa, while node D points to node E, etc. At any moment in time, the entire network appears as though it has been “hard wired” or connected in a particular configuration and that configuration or connectivity diagram can be changed dynamically by the network operations controller.

With conventional sector beams operating in a conventional TDMA system, the nodes in a sector are all visible to each other and the scheduling of the signal burst period (time slot) is the only mechanism that determines the instantaneous interconnection between nodes. In addition, because the wide beams have relatively low gain, the link quality and the allowable channel reuse factors are limited. In a TDMA system, the channel reuse refers to the simultaneous use of the same frequency and time slot for multiple independent links.

The present invention provides a substantial improvement to the network link parameters, connectivity, and capacity by creating narrow directional beams between interconnected nodes during the scheduled time slot while, at the same time, reducing the potential for interference, thereby allowing substantial improvement to the spectral efficiency for a service operator's allocated frequencies.

The scheduling of the mutual beam directions may be accomplished in a straightforward manner by, for example, having the beams pointed according to an assignment table that maps time slots to node pairs. The optimization of the instantaneous connectivity pattern for the overall network is a well-understood problem in network management and practical solutions are known to those skilled in those arts, however this information usually applies to fixed network nodes within an architecture, and not a dynamically adaptive network.

For a hub topology, the invention provides the advantages of a high gain directional beam at a particular instant of time. In this case, the hub sequentially, or adaptively (depending on traffic) points its beam to one of the user sites within its field of view. The user site typically always points its beam to the hub so its beam does not generally need to be steerable. The invention applies to mobile users provided that the remote unit can steer its beams as well as can the base station. It also applies to portable applications where the remote user is stationary while being used but where its geographical location changes from time to time (e.g. a user carrying a laptop and wanting Internet or email access from the wireless network.)

This invention, whether for hub or mesh architectures, provides high utilization efficiency for a given spectrum allocation and permits improved link quality. By incorporating narrow beams a link relative gain of 6 to 10 dB or more may be available compared with a wide sector beam. For example, the available output power of solid state amplifiers at 24 GHz and above is limited for linear backed-off operation to values typically less than one watt. High antenna gain permits a wider internode spacing for a given transmit power and link availability. Also, higher antenna gain could permit higher order modulations (such as n-QAM) for a given power and node separation. This would allow more individual channels within a spectrum allocation subject to the linearity and interference limitations mentioned above.

Ultimately, a network with a single steerable beam may reach its capacity limit, although this would happen much later in the deployment and operating lifetime than for a system incorporating sector beams. In that event, multiple beams at each node may be employed. These beams would reuse the same frequencies and therefore be subject to some constraints on sidelobe levels and possibly polarization. The invention described herein also incorporates multiple beam antennas with high gain beams. At each node, for a given sector of coverage, the nodes can be simultaneously connected with multiple beams from the same aperture.

The network management must be such that the beams obey spatial (angle) separation rules to maintain an acceptable ratio of received carrier-to-noise plus interference power [c/(n+i)]. Yet, a single multi-beam antenna, such as a phased array with multiple beams or a lens with multiple feeds, each producing a beam in a particular direction in space, can offer installation, maintenance, and operational advantages as compared with adding separate apertures.

The advantage of dynamic reconfigurability is most evident when one considers the scenario where a new node is introduced to the network. In the case of prior art networks with broad sector beams, such a new node poses no problem as long as it is within the coverage of an existing sector. However, even then, bandwidth resources may be strained because of the relatively low antenna gain of the sector beam and the traffic requirements of the new node.

On the other hand, with high gain steerable beams of the present invention, it is a simple matter to add the new node's location to a network connection table (for example) and to interconnect it with the rest of the network by a software command at the operations center. Therefore, such dynamically reconfigurable networks offer substantial operations cost savings.

One issue for narrow beams is that of acquisition. When no beam is pointed at a node and when that node must access the system, a means must exist for the node to communicate its needs. This can be accomplished in several ways. In one instance, a separate broad beam might be employed that always maintains a link, albeit at a low data rate, with the other nodes in its view. This could be accomplished with a separate antenna and it could also be accomplished with a beam from an array aperture that has been broadened, by adjusting the phase shifters in the array to synthesize a broad beam. Alternatively, a separate low-gain antenna could be employed, if appropriate. With broad beams at each node, access is assured provided the data rate for this “signaling” channel is low enough to maintain a link in the most severe rain.

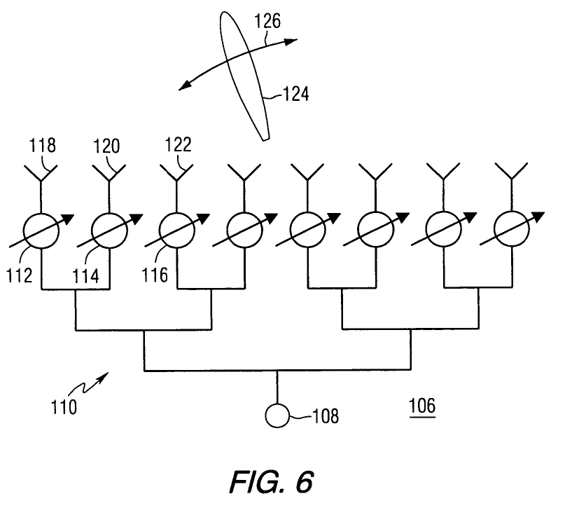

Multiple beam and scanning beam antennas are known in the art. FIG. 6 shows an example of a phased array antenna 106 having an input 108 connected to a divider network 110. A plurality of phase shifters, for example 112, 114 and 116, are used to control the phase of a signal delivered to radiating elements 118, 120 and 122. This produces a radiation beam 124 that can be scanned in the direction indicated by arrow 126. The beam direction is determined by applying specific values to the phase shifters. These phase shift values may be digital discrete values or analog (continuous) values depending on the implementation of the phase shifters. While the antenna has been described as a transmitter antenna, it will be appreciated by those skilled in the art that when used as a receiver antenna, network 110 serves as a combiner network and input 108 serves as an output.

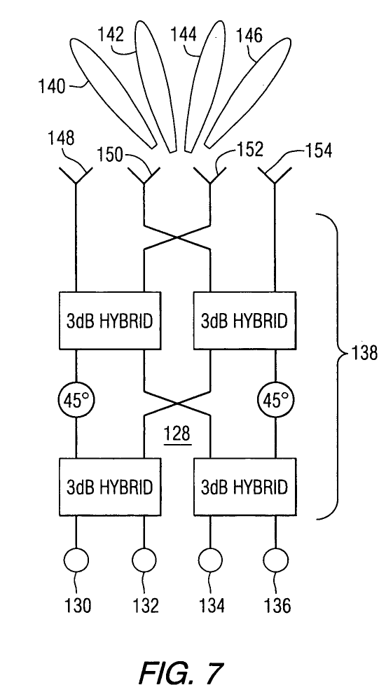

FIG. 7 depicts a multiple beam antenna array 128. In this case signals provided on a plurality of inputs 130, 132, 134 and 136 are coupled to a Butler Matrix beam-forming network 138 to produce a set of simultaneous beams 140, 142, 144 and 146, which emanate from radiating elements 148, 150, 152 and 154.

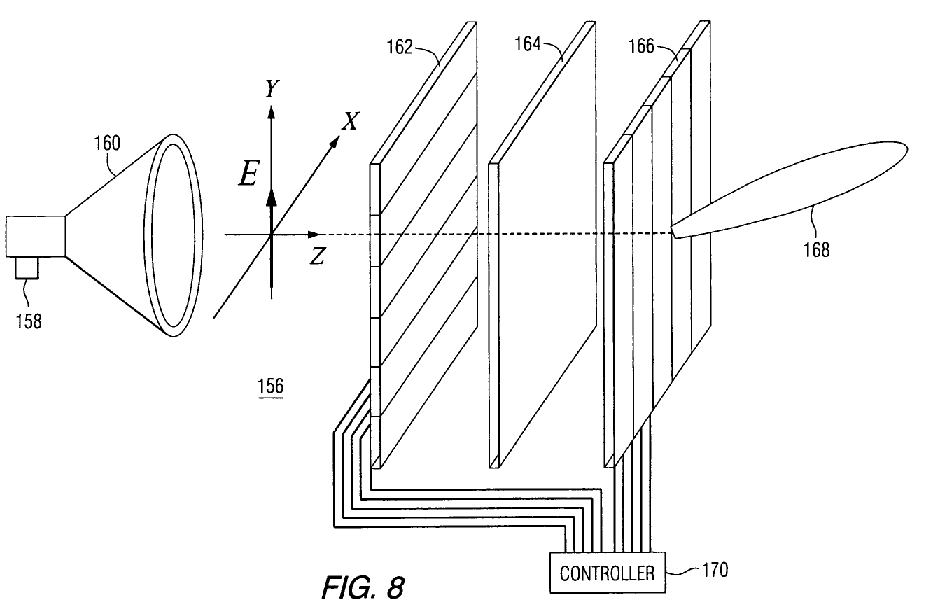

FIG. 8 depicts a lens or space fed array 156 where a signal supplied to input 158 passes through the feed horn 160 and illuminates a set of phase shifters 162, a linear polarization rotator 164 and radiating array elements 166 to cause the radiated energy 168 emanating from the aperture to be steered in two dimensions (e.g. azimuth and elevation). Controller 170 controls the direction of the beam.

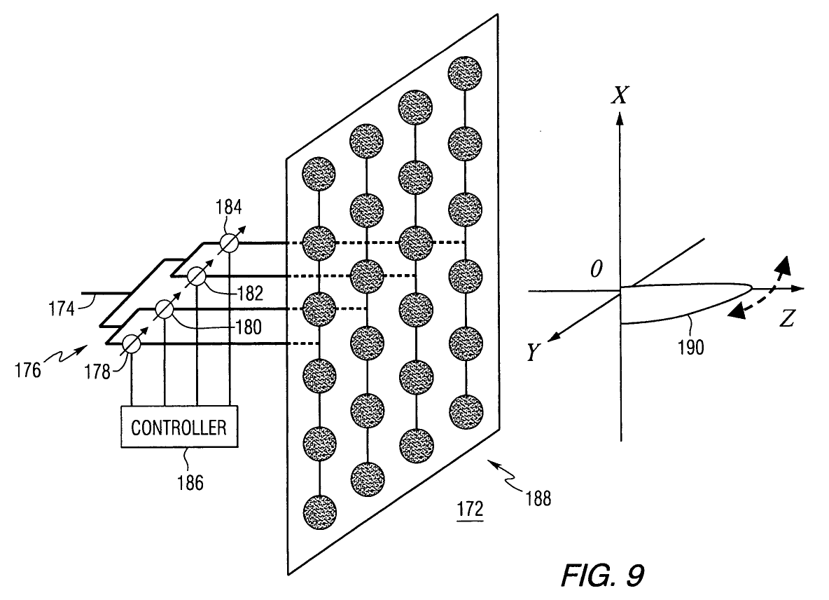

FIG. 9 depicts a phased array 172 that includes an input 174, divider network 176 and phase shifters 178, 180, 182 and 184. A controller 186 controls the phase shift of the signals provided to radiating elements 188 such that rows of radiating elements are excited with a fixed set of amplitudes and phases, and the columns are excited with variable phase shifts to steer the beam 190 in one dimension, e.g. for azimuth scan in a wireless network.

In addition to the communications network described above, this invention also encompasses methods of operating dynamically reconfigurable networks. In point-to-point and point to multi-point TDMA communication systems, the use of a wide beam antenna system means lower antenna gain. Much more power is needed both for network system and user terminals to get the same level of communication quality compared with that using high gain antenna systems. To get high gain antenna systems for the saving of transmitting or receiving power, this invention uses narrow beam array antennas. The high gain narrow beam array antenna systems cannot cover a wide communication area. The transmitting/receiving beam direction should be steered with high speed during the communications without interruption. Because of the narrow beam, low side lobes and low back lobes of the steerable or switchable beam antenna system, the interference of the undesired signals will be reduced.

The invention is not restricted to any unique frequency range. In fact, the invention applies to a wide range of frequencies, from low frequencies to high, including optical wavelengths. For example, optical links may be set up between nodes using lasers with very narrow optical beams. All that is required is that a node be able to command the beam(s) in different directions at different times. In addition, multiple lasers pointing in different directions can be used.

At low frequencies, it is simply required that the antennas form steerable or switchable beams. The restrictions here are only economic, as the basic beam steering or beam switching technology is understood. These networks may also have application to secure communications, such as for the military or other intelligence or defense systems. The invention can also include purposeful dynamic spatial spreading of parts of a signal over different routes to be reassembled at a particular node, to provide secure communications. For example, a secure communications system might transmit part of its message and/or part of its message encoding or encryption to one node during a burst, then to another node during another burst, and so forth. The complete message would require that each node re-transmit its parts (perhaps in jumbled order) to a destination node for reconstruction. An interception of any one or even several (but not all) node signals would only gather a part of the message and only part of the encryption. It would be more difficult to intercept and decode messages sent by such a spatial spreading scheme.

There is no absolute requirement for both transmit and receive antennas to be directive. Combinations of directive transmit and sector receive antennas, or vice versa, may be easily implemented within the scope of the invention.

The invention also has applicability to satellite networks where one or more of the nodes is/are satellites and some of the nodes are earth terminals. This could apply to ground terminals viewing more than one satellite, ground terminals such as gateways interconnected to a terrestrial wireless network, and other satellite networks.

While the present invention has been described in terms of what are at present believed to be its preferred embodiments, those skilled in the art will recognize that various modifications to the disclose embodiments can be made without departing from the scope of the invention as defined by the following claims.

1. A wireless communication network comprising:
a plurality of nodes, each having at least one dynamically directionally controllable communications link, wherein each of the dynamically directionally controllable communications links comprises an electronic scanning antenna adapted to provide a narrow-angle beam for transmitting communications signals via the communications link and a wide-angle beam for acquiring the communications link and capable of multiple beams being generated from a single antenna and independently steered; and
a network controller for dynamically changing the direction of the controllable communications links of the nodes to enable transmission of signals between the nodes.

2. The wireless communication network of claim 1, wherein selected ones of the nodes further include an additional dynamically directionally controllable communications link.

3. The wireless communication network of claim 1, further comprising: a low data rate signaling channel for transmitting control information from the network controller to the nodes.

4. The wireless communication network of claim 3, wherein the signaling channel includes the wide-angle antenna beam at each of the nodes.

5. The wireless communication network of claim 1, wherein the network controller changes the direction of the controllable communications links during a guard interval between the transmission and reception of information signals between pairs of the nodes.

6. The wireless communication network of claim 1, wherein each of the nodes includes an antenna producing at least one dynamically directionally controllable beam.

7. The wireless communication network of claim 6, wherein each of the dynamically directionally controllable beams is a narrow beam.

8. The wireless communication network of claim 1, further comprising a connector for connecting one of said nodes to a backbone circuit.

9. The wireless communication network of claim 1, wherein at least one of said nodes is a satellite and at least one other of said nodes is a ground station.

10. A method capable of transmitting communications signals comprising;
receiving communications signals by a plurality of nodes, each having at least one dynamically directionally controllable communications link, wherein each of the dynamically directionally controllable communications links comprises an electronic scanning antenna adapted to provide a narrow-angle beam for transmitting communications signals via the communications link and a wide-angle beam for acquiring the communications link and capable of multiple beams being generated from a single antenna and independently steered; and
dynamically changing the direction of the controllable communications links of the nodes to enable transmission of the communications signals between the nodes.

11. The method of claim 10, further comprising transmitting control information from the network controller to the nodes on a low data rate control channel.

12. The method of claim 11, wherein the network controller changes the direction of the controllable communications links during a guard interval between the transmission and reception of information signals between pairs of the nodes.

13. The method of claim 11, further comprising connecting one of said nodes to a backbone circuit.

14. The method of claim 11, further comprising dynamically spreading the communications signal over multiple routes among the nodes and reassembling the communications signal at a predetermined node.

15. A wireless communication network comprising:
a hub node having at least one dynamically directionally controllable communications link comprising an electronic scanning antenna adapted to provide a narrow-angle beam for transmitting communications signals via the communications link and a wide-angle beam for acquiring the communications link and capable of multiple beams being generated from a single antenna and independently steered;
a plurality of remote nodes; and
a network controller for dynamically controlling the direction of the communications link to enable transmission of signals between the hub node and the remote nodes,

16. The wireless communication network of claim 15, wherein the hub node further includes an additional dynamically directionally controllable communications link.

17. The wireless communication network of claim 15, further comprising: a low data rate signaling channel for transmitting control information from the network controller to the hub node.

18. The wireless communication network of claim 15, wherein the signaling channel includes a wide-angle antenna beam at the hub node.

19. The wireless communication network of claim 15, wherein the network controller changes the direction of the controllable communications links during a guard interval between the transmission and reception of information signals between pairs of the nodes.

20. The wireless communication network of claim 15, wherein the hub node includes an antenna producing at least one dynamically directionally controllable beam.

21. The wireless communication network of claim 15, further comprising: means for connecting one of said hub nodes and said remote nodes to a backbone circuit.

22. The wireless communication network of claim 15, wherein at least one of said remote nodes is a satellite; and the hub node is a ground station.

23. The wireless communication network of claim 1, wherein a single multi-beam aperture contains a plurality of simultaneous fixed beam positions, which are selectively activated to enable beam switching.
